(19) United States
(12) Patent Application Publication
(10) Pub. No.: US 2017/0198635 A1
(43) Pub. Date: Jul. 13, 2017

(54) HIGH FLOW ON-LINE WATER WASH USING SPRINT NOZZLE

(71) Applicant: General Electric Company, Schenectady, NY (US)

(72) Inventors: Manjunath Subbarao, Houston, TX (US); Roman Freidl, Houston, TX (US); John Harrell, Houston, TX (US); Daryl Popplewell, West Chester, OH (US); Feng Gao, West Chester, OH (US); Harley Matthew Ross, Houston, TX (US)

(21) Appl. No.: 14/990,505

(22) Filed: Jan. 7, 2016

(51) Int. Cl. F02C 7/143; F02C 3/30; F02C 3/04

(52) U.S. Cl. CPC F02C 7/1435; F02C 3/04; F02C 3/30

(57) ABSTRACT

A combined water-wash and water injection cooling system for a gas turbine engine including a water delivery system, an air delivery system, and a controller configured to couple to the gas turbine engine, the water delivery system, and the air delivery system to access and execute one or more routines. The water delivery system includes one or more spray nozzles to spray water upstream and directly in front of a compressor of the gas turbine engine. The air delivery system is configured to provide air from the compressor to the water delivery system so that the one or more spray nozzles spray atomized water into the compressor of the gas turbine engine during a cooling mode to cool the compressor. During an on-line water wash mode, air from the air delivery system to the water delivery system is turned off to enable the one or more spray nozzles to spray non-atomized water into the compressor of the gas turbine engine to wash the compressor.

### BACKGROUND

This disclosure relates to gas turbine engines and more particularly relates to an on-line water wash system for gas turbine engines.

Gas turbine engines typically include a compressor for compressing a working fluid, such as air. The compressed air is injected into a combustor which heats the fluid causing it to expand, and the expanded fluid is forced through a turbine. As the compressor consumes large quantities of air, small quantities of dust, aerosols and water pass through and deposit on the compressor (e.g., deposit onto blades of the compressor). These deposits impede airflow through the compressor and degrade overall performance of the gas turbine over time. Therefore, gas turbine engines are periodically shutdown and washed to clean and remove contaminants from the compressor; such an operation is referred to as an offline wash operation (e.g., offline wash operation is performed while the gas turbine engine is shutdown). Contrarily, an on-line water wash operation allows the compressor wash to be performed while the engine is in operation. As such, an on-line water wash operation reduces the downtime of the gas turbine, extends the period between offline washes, and improves performance in the interim.

In most of the current on-line water wash systems for gas turbine compressors, the nozzles of the system are located in positions upstream or directly at the inlet to the compressor bellmouth casing. A spray of water droplets are injected from the nozzles through the bellmouth and into the compressor inlet. The injected water has to travel through several stages of a low pressure compressor and many stages of a high pressure compressor. During on-line water wash, it is difficult for the injected water to travel all the way through the running blades of compressors, and chances of contaminants depositing on high pressure compressor blades are high. Furthermore, most of the current water wash systems are separate skids from the gas turbine compressors, and the implementation of water wash skids adds additional costs to the overall operation.

There is a desire, therefore, for an on-line water wash system that provides effective cleaning of turbine compressors, and is also cost-effective. It is preferred that the resultant cleaning will be as effective, if not more effective, than commonly known systems.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a combined water-wash and water injection cooling system for a gas turbine engine includes a water delivery system configured to couple to the gas turbine engine, wherein the water delivery system includes a water conduit, and one or more spray nozzles coupled to the water conduit and configured to spray a fluid into a compressor of the gas turbine engine. The combined water-wash and water injection cooling system for the gas turbine engine also includes an air delivery system configured to couple to the compressor and to the water delivery system, wherein the air delivery system includes an air conduit coupled to the water conduit, and the air delivery system is configured to provide air from the compressor to the water delivery system so that the one or more spray nozzles spray atomized water into the gas turbine engine into the compressor, respectively, during a cooling operation mode to cool the compressor. The combined water-wash and water injection cooling system for the gas turbine engine further includes a controller configured to couple to the gas turbine engine, the water delivery system, and the air delivery system, wherein the controller comprises a memory encoding one or more processor-executable routines and a processor configured to access and execute the one or more routines encoded by the memory. The routines, when executed cause the processor to turn off air from flowing from the air delivery system to the water delivery system to enable the one or more spray nozzles to spray non-atomized water into the compressor of the gas turbine engine, during an on-line water wash mode to wash the compressor.

In a second embodiment, a method includes operating a combined water-wash and water injection cooling system coupled to a gas turbine engine. The method also includes turning off, via a first control signal from a controller, a flow of air from an air delivery system coupled to a compressor of the gas turbine engine to a water delivery system. The method further includes in an on-line water wash mode to wash the compressor, spraying water, via the water delivery system, into the compressor of the gas turbine engine while the gas turbine engine is operating and subsequent to turning off the flow of air from the air delivery system to the water delivery system.

In a third embodiment, a gas turbine engine controller includes a memory encoding one or more processor-executable routines, and a processor programmed to access and execute the one or more routines encoded by the memory. The routines, when executed cause the processor to turn off a flow of air from a compressor of a gas turbine engine, via an air delivery system, to a water delivery system, and subsequent to blocking the flow of air, spray water via the water delivery system into the compressor of the gas turbine engine while the gas turbine engine is operating to clean the compressor.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a schematic illustration of a turbine system, in accordance with an embodiment;

FIG. 2 is a schematic illustration of a water injection assembly used with the gas turbine engine shown in FIG. 1, in accordance with an embodiment;

FIG. 3 is a flow chart illustrating a method for operating the water injection assembly shown in FIG. 2 for cooling operation and subsequently high flow on-line water wash operation, in accordance with an embodiment; and

FIG. 4 is a flow chart illustrating a method for operating the water injection assembly shown in FIG. 2 for high flow on-line water wash operation and subsequently cooling operation, in accordance with an embodiment.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed to a high flow on-line water wash system for gas turbine engines. In certain embodiments, the high flow on-line water wash system uses an existing cooling system that injects a fluid (e.g., water/demineralized water) in front of the low pressure compressor, the high pressure compressor, or both (e.g., SPRINT™ nozzles). A control logic controls both the cooling operation (e.g., to cool the compressor) and on-line water wash operation. During the cooling operation, air from the eighth stage bleed of the high pressure compressor is used for water atomization to inject atomized water in front of both the low and high pressure compressors to cool them. However, during the high flow on-line water wash operation, the eighth stage bleed air is turned off by using a solenoid valve, and demineralized water is used for the operation. By turning off the air, the cooling operation is cased and droplets of demineralized water are introduced in front of one or both of the compressors for high flow on-line water wash through the existing water injection nozzles. The one or more nozzles are positioned upstream and directly in front of the compressor, instead of in front of the bell mouth. This helps clean one or both of the low pressure and high pressure compressors thoroughly. As such, the efficiency of the compressor may be recovered, which in turn increases the performance of the turbine engine, leading to lower power generation cost and lower fuel cost. In addition, as the disclosed high flow on-line water wash operation can be performed while the turbine engine is in operation, this also reduces the downtime of the turbine engine. Furthermore, the disclosed high flow on-line water wash system uses the existing water/demineralized water supply and hardware utilized for the cooling operation, and thereby eliminates the need for using a separate water wash skid (e.g., saving costs by using one water skid for both cooling and on-line water wash operations).

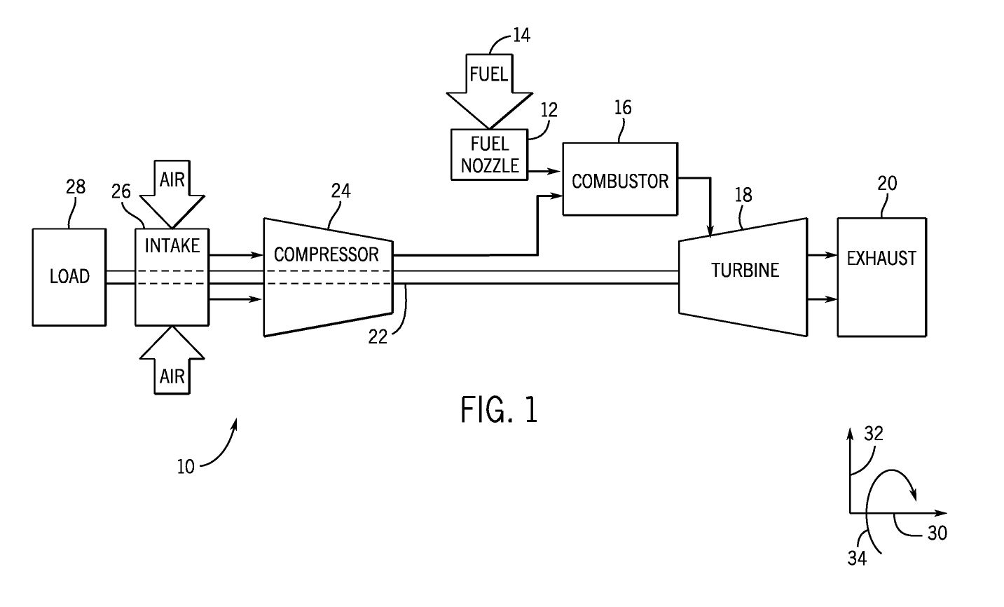

FIG. 1 is a schematic of an embodiment of a turbine system 10. As described in detail below, the disclosed turbine system 10 (e.g., a gas turbine engine) may employ an end cover with fuel plenums, described below, which may improve fuel distribution and improve system durability, operability, and reliability. The turbine system 10 may use liquid or gas fuel, such as natural gas and/or a hydrogen rich synthetic gas, to drive the turbine system 10. As depicted, fuel nozzles 12 (e.g., multi-tube fuel nozzles) intake a fuel supply 14, mix the fuel with an oxidant, such as air, oxygen, oxygen-enriched air, oxygen reduced air, or any combination thereof. Although the following discussion refers to the oxidant as the air, any suitable oxidant may be used with the disclosed embodiments. Once the fuel and air have been mixed, the fuel nozzles 12 distribute the fuel-air mixture into a combustor 16 in a suitable ratio for optimal combustion, emissions, fuel consumption, and power output. The turbine system 10 may include one or more fuel nozzles 12 located inside one or more combustors 16. The fuel-air mixture combusts in a chamber within the combustor 16, thereby creating hot pressurized exhaust gases. The combustor 16 directs the exhaust gases through a turbine 18 toward an exhaust outlet 20. As the exhaust gases pass through the turbine 18, the gases force turbine blades to rotate a shaft 22 along an axis of the turbine system 10. As illustrated, the shaft 22 may be connected to various components of the turbine system 10, including a compressor 24. The compressor 24 also includes blades coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. The load 28 may include any suitable device capable of being powered by the rotational output of the turbine system 10. The turbine system 10 may extend along an axial axis or direction 30, a radial axis or direction 32 toward or away from the axis 30, and a circumferential axis or direction 34 around the axis 30. The fuel nozzle 12 may contain or connect with an end cover having fuel plenums, described below, which may improve fuel distribution by feeding fuel directly into fuel injectors, which may feed fuel into tubes where it premixes with air before being released to the combustor 16.

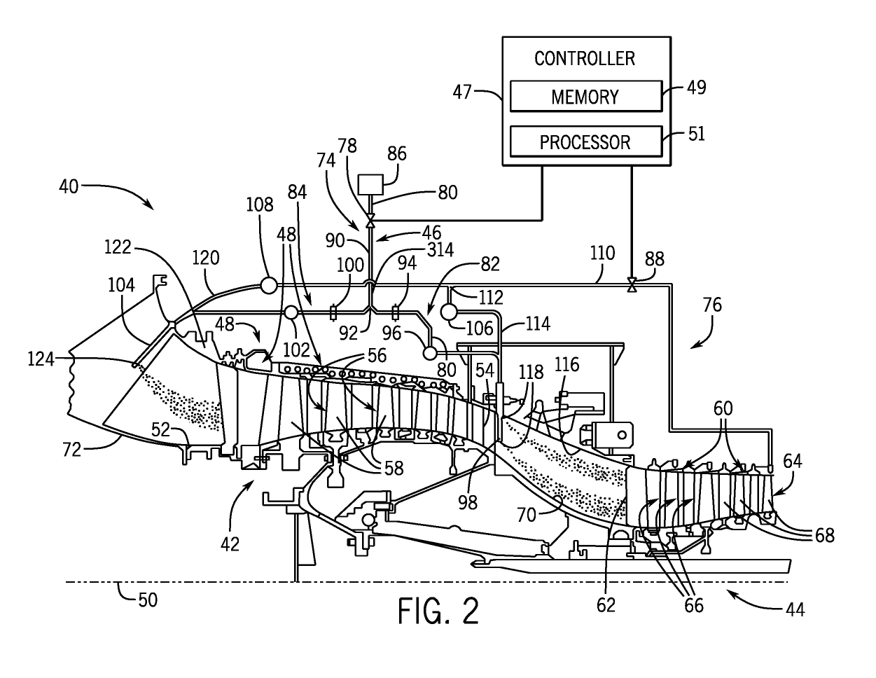

FIG. 2 is a schematic illustration of a compressor rotor assembly 40 used with a gas turbine engine similar to the turbine system 10 shown in FIG. 1. In one embodiment, the gas turbine engine is an LM6000 available from General Electric Aircraft Engines, Cincinnati, Ohio. The compressor rotor assembly 40 includes a low pressure compressor 42, and a high pressure compressor 44. The compressor rotor assembly 40 also includes a water injection assembly 46 and a controller 47. The low pressure compressor 42 includes a plurality of rotors 48 coupled together and coaxial with an axial centerline axis 50 of the compressor rotor assembly 40. The rotors 48 extend axially along the centerline axis 50 from an inlet side 52 of the low pressure compressor 42 to an exhaust side 54 of the low pressure compressor 42.

It will be appreciated that the operation of water injection assembly 46 is controlled/regulated by the controller 47. In the illustrated embodiment, the controller 47 includes a memory 49 (e.g., a non-transitory computer-readable medium/memory circuitry) storing one or more sets of instructions (e.g., processor-executable instructions) implemented to operate the water injection assembly 46. The controller 47 also includes one or more processor 51 configured to access and execute the one or more sets of instructions encoded by the memory 49, associated with the water injection assembly 46 to perform the cooling operation and the on-line water wash operation, among other functions.

More specifically, the memory 49 may include volatile memory, such as random access memory (RAM), and/or non-volatile memory, such as read-only memory (ROM), optical drives, hard disc drives, or solid-state drives. Additionally, the one or more processor 51 may include one or more application specific integrated circuits (ASICs), one or more field programmable gate arrays (FPGAs), one or more general purpose processors, or any combination thereof. Furthermore, the term processor is not limited to just those integrated circuits referred to in the art as processors, but broadly refers to computers, processors, microcontrollers, microcomputers, programmable logic controllers, application specific integrated circuits, and other programmable circuits.

Each of the rotors 48 of the low pressure compressor 42 is formed by one or more bladed disks 56, and each of the bladed disks 56 includes a plurality of blades 58 extending radially outwardly from the axial centerline axis 50. Each row of the bladed disks 56 is sometimes referred to a rotor stage. The blades 58 cooperate with a motive or working fluid, such as air, and compress the motive fluid in succeeding rotor stages as the blades 58 rotate about the axial centerline axis 50.

The high pressure compressor 44 includes a plurality of rotors 60 coupled together coaxially with the axial centerline axis 50. The rotors 60 extend axially along the axial centerline axis 50 from an inlet side 62 of the high pressure compressor 44 to an exhaust side 64. Each of the rotors 60 of the high pressure compressor 44 is formed by one or more bladed disks 66, and each of the bladed disks 66 includes a plurality of blades 68 extending radially outwardly from the axial centerline axis 50. Each row of the bladed disks 66 is sometimes referred to a rotor stage. The blades 68 cooperate with a motive or working fluid, such as air, and compress the motive fluid in succeeding rotor stages as the blades 68 rotate about the axial centerline axis 50.

A duct 70 extends from the low pressure compressor exhaust side 54 to the high pressure compressor inlet side 62. The duct 70 is annular and directs the motive or working fluid exiting the low pressure compressor 42 to the high pressure compressor inlet side 62. An inlet duct 72 directs the motive or working fluid towards the low pressure compressor inlet side 52.

The water injection assembly 46 injects water to the gas turbine engine simultaneously within the ducts 70 and 72 and includes a water delivery system 74 and an air delivery system 76. The water injection assembly 46 injects water to the ducts 70 and 72 separately and independently. In another embodiment, the water injection assembly 46 does not include the air delivery system 76 and includes a plurality of pressure atomized nozzles (not shown) to atomize the water. The water delivery system 74 includes a metering valve 78, a plurality of piping 80, a high pressure compressor portion 82, and a low pressure compressor portion 84. The piping 80 connects the water injection assembly 46 to a water supply source or reservoir 86 and extends from the water supply source 86 to the metering valve 78. The metering valve 78 is controlled by the controller 47 (e.g., via an actuator). The controller 47 may control the metering valve 78 to control/regulate the amount and rate of water flowing from the water supply source 86 to the water injection assembly high pressure compressor portion 82 and the water injection assembly low pressure compressor portion 84. In one embodiment, the water supply source 86 supplies demineralized water instead of water.

The air delivery system 76 supplies air from an eighth stage bleed (not shown) of the high pressure compressor 44 to the water injection assembly 46 via a solenoid valve 88. The eighth stage bleed serves as a source of heated air to atomize water. The solenoid valve 88 is controlled by a controller 47 (e.g., via an actuator). The solenoid valve 88 controls or regulates airflow from the eighth stage bleed port to the water injection assembly 46. Specifically, the controller 47 may receive instructions to maintain the solenoid valve 88 in an open position and regulate the amount and rate of the airflow through the solenoid valve 88 during the cooling operation (e.g., for water atomization). The controller 47 may also receive instructions to close the solenoid valve 88 to stop the airflow to the water injection assembly 46 during the on-line water wash operation while the cooling operation is ceased.

Additional piping 90 extends between the metering valve 78 and a T-fitting 92. The T-fitting 92 splits the water flow between the water injection assembly system portions 82 and 84. A portion of the water entering the T-fitting 92 is directed into the water assembly high pressure compressor portion 82 and through an orifice 94 in the piping 90 to increase the pressure of the water before it flows into a water manifold 96. In another embodiment, water entering the T-fitting 92 is directed into a first valve (not shown) disposed in the high pressure compressor portion 82 to independently control the flow of water into the high pressure compressor portion 82. The remaining water is directed into the water assembly low pressure compressor portion 84. In an alternative embodiment, the remaining water is directed into a second valve (not shown) disposed in the low pressure compressor portion 84 to independently control the flow of water into the low pressure compressor portion 84. The manifold 96 is connected with the piping 90 to a plurality of spray nozzles 98 positioned upstream from the high pressure compressor inlet side 62. In one embodiment, the water assembly high pressure compressor portion 82 includes twenty-four spray nozzles 98. The manifold 96 is annular and is circumferentially positioned around the low pressure compressor 84 to supply a consistent water flow to the spray nozzles 98. The spray nozzles 98 are positioned circumferentially around the duct 70 downstream of the low pressure compressor exhaust side 54 and upstream of the high pressure compressor inlet side 62. Water exiting the spray nozzles 98 is directed into the gas turbine engine airflow towards the high pressure compressor 44.

The remaining water entering the T-fitting 92 is directed into the water assembly low pressure compressor portion 84 and the water assembly high pressure compressor portion 82 through orifices 100 and 94, respectively. In one embodiment, the orifices 100 and 94 are valves used to selectively control a flow of water. The orifices 100 and 94 provide a proper mixture of water between the water assembly low pressure compressor portion 84 and the water assembly high pressure compressor portion 82. A manifold 102 is connected with the piping 90 to a plurality of spray nozzles 104 positioned upstream from the low pressure compressor inlet side 52. Water exiting the spray nozzles 104 is directed downstream into the gas turbine engine airflow towards the low pressure compressor 42. In one embodiment, the low pressure compressor portion spray nozzles 104 are identical to the high pressure compressor portion spray nozzles 98.

The air delivery system 76 includes a first manifold 106, a second manifold 108, and a plurality of piping 110 and provides a consistent bleed airflow from the eighth stage bleed port (not shown) to the piping 90. The piping 110 connects the air delivery system 76 to the solenoid valve 88 to receive bleed air from the eight stage of the high pressure compressor 44. The piping 110 extends between the solenoid valve 88 and a splitter joint 112.

A portion of the air entering the splitter joint 112 is directed towards the first manifold 106 and the remaining air is directed towards the second manifold 108. The first manifold 106 is annular and is circumferentially positioned around the low pressure compressor 42 downstream from the second manifold 108. A plurality of feeder tubes 114 extend from the first air manifold 106 to the spray nozzles 98. The feeder tubes 114 permit bleed air and water to flow from the air manifold 106 to the spray nozzles 98. The spray nozzles 98 extend radially inward towards the axial centerline axis 50 from an outer wall 116 of the duct 70 and include a plurality of spray outlets 118. The bleed air atomizes the water being sent to the spray nozzles 98 to create water droplets. The droplets are forced into the flow path through the spray nozzle spray outlets 118. In one embodiment, a mean particle diameter size of the abovementioned water droplets is approximately 20 microns.

The remaining air entering the splitter joint 112 is directed towards the second manifold 108. The second manifold 108 is annular and is circumferentially positioned around the low pressure compressor 42 upstream from the first manifold 106. A plurality of feeder tubes 120 extend from the second air manifold 108 to the spray nozzles 104. The feeder tubes 120 permit bleed air and water to flow from the second air manifold 108 to the spray nozzles 104. The spray nozzles 104 extend radially inward towards the axial centerline axis 50 from an outer wall 122 of the inlet duct 72 and include a plurality of spray outlets 124. The bleed air atomizes the water being sent to the spray nozzles 104 to create water droplets. The droplets are forced into the flow path through the spray nozzle spray outlets 124 in fine mist directed towards the low pressure compressor inlet side 52. In one embodiment, the water mist exits the spray nozzle spray outlets 124 with a mean particle diameter size of 20 microns.

When the gas turbine is in operation, a working fluid, such as air, is routed through the low pressure compressor 42 with the inlet duct 72. The compressed fluid flow exits the low pressure compressor 42 and is routed through the duct 70 to the high pressure compressor 44. Accordingly, as air flows through the gas turbine engine, compressor bleed air flows from the high pressure compressor 44 to the air system splitter joint 112. A portion of the air is directed towards the air system first manifold 106 and the remaining air is directed towards the air system second manifold 108. Simultaneously, cooling operation is performed while the gas turbine engine is in operation. Water flows through the metering valve 78 and is directed into the water delivery high pressure compressor portion 82 and the water delivery low pressure compressor portion 84.

The bleed air exiting the air manifolds 106 and 108 atomize the water flowing to the water delivery spray nozzles 98 and 104, respectively, and creates a fine mist. The mist is directed towards the high pressure compressor inlet side 62 and the low pressure compressor inlet side 52, respectively. The mist creates a supersaturated condition at the low pressure compressor inlet side 52. As the mist flows through the low pressure compressor 42 and the high pressure compressor 44, the mist evaporates creating an intercooling effect within the gas turbine engine. The intercooling effect permits lower firing temperatures and lower compressor exit temperatures. Specifically, the mist extracts heat from the hot air flowing into and through the compressors 42 and 44 and along with the required compressor power. That is by injecting atomized water spray in front of the compressors 42 and 44, the temperatures at the inlet sides 52 and 62 are significantly reduced. Therefore, using the same compressor discharge temperature control limits, the compressors 42 and 44 are able to pump more air, achieving higher pressure ratios. This results in higher output and improved efficiency.

The above described water injection assembly 46 may also be utilized for on-line water wash operation. Since the same water injection assembly 46 is used for both water injection operation and on-line water wash operation, the use of a separate water wash skid is eliminated. During on-line water wash operation, demineralized water instead of water may be supplied using water delivery system 74 (e.g., water supply source or reservoir 86 supplies demineralized water). Further, during the on-line water wash operation, the solenoid valve 88 is turned off by the controller 47. By turning off the eight stage bleed air, non-atomized water droplets are introduced in front of one or both each of the compressors 42 and 44 for water wash. In addition, since the water is injected separately in front of the low pressure compressor 42 and the high pressure compressor 44 using the nozzles 104 and 98, respectively, the compressors can be cleaned effectively, thereby increase the efficiency of the turbine engine.

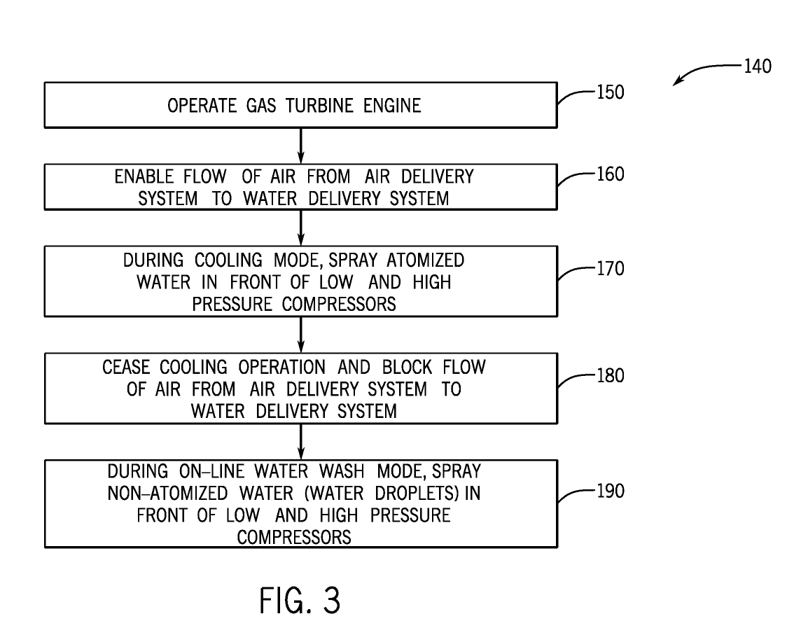

FIG. 3 is a flow chart illustrating a method 140 for operating the water injection assembly 46 for cooling operation and subsequently high flow on-line water wash operation. One or more of the steps of the method 140 may be executed by the controller 47. The method 140 includes operating the gas turbine engine (step 150). The method 140 also includes maintaining the solenoid valve 88 in an open position to enable flow of air from the air delivery system 76 to the water delivery system 74 (step 160), while the metering valve 78 is also maintained in an open position to enable water flow in the water injection assembly 46 through the water delivery system 74. The method 140 further includes operating the water injection assembly 46 under cooling mode to spray atomized water in front of the low pressure compressor 42 and the high pressure compressor 44 for cooling operation (step 170). Specifically, the atomized water is injected through the spray nozzles 104 and 98, positioned upstream and directly in front of the low pressure compressor 42 and the high pressure compressor 44 to cool each of the compressors 42 and 44.

Further, the method 140 includes ceasing the cooling operation and preparing the water injection assembly 46 for on-line water wash operation (step 180), which includes closing the solenoid valve 88 to turn off flow of air from the air delivery system 76 to the water delivery system 74. In addition, the controller 47 may control/regulate the metering valve 78 and/or the orifices 100 and 94 such that the amount and rate of the water flow into the low pressure compressor 42 and the high pressure compressor 44 are adjusted for the water injection assembly 46 to operate under water wash mode.

The method 140 also includes during on-line water wash mode, spraying via the water injection assembly 46 non-atomized water/water droplets in front of the low pressure compressor 42 and the high pressure compressor 44 (step 190). Specifically, non-atomized water (or demineralized water) is injected through the spray nozzles 104 and 98, positioned upstream and directly in front of the low pressure compressor 42 and the high pressure compressor 44, respectively. Water droplets travel through different stages of the low pressure compressor 42 and the high pressure compressor 44, and clean blades thoroughly. The water flow rate may be at least 20 gallon (or 75 liter) per minute into the low pressure compressor 42, and at least 13 gallon (or 49) per minute into the high pressure compressor 44. In another embodiment, method 140 may include during on-line water wash mode, spraying non-atomized water/water droplets in front of only one of the compressors 42 and 44, and the other compressor 42 or 44 may be washed via a traditional on-line water wash method.

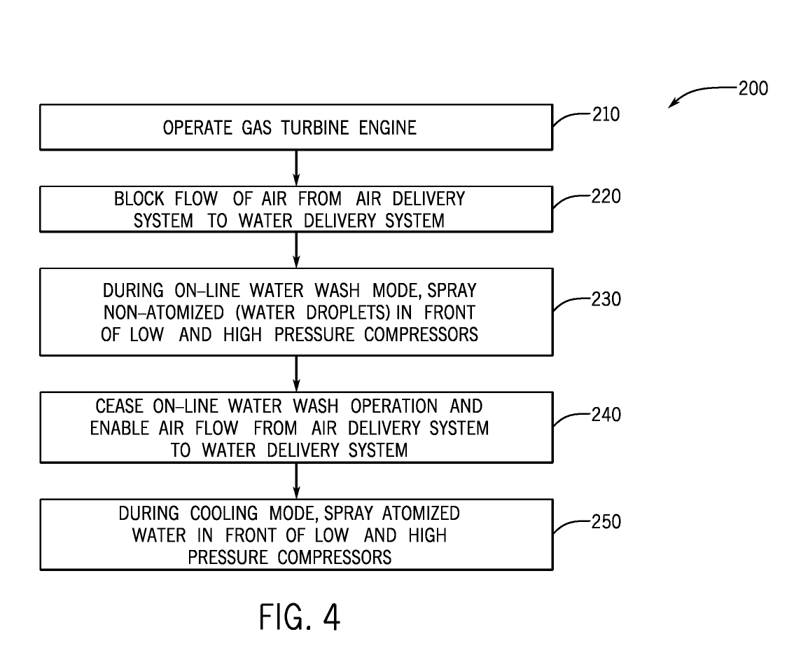

FIG. 4 is a flow chart illustrating a method 200 for operating the water injection assembly 46 for high flow on-line water wash operation and subsequently cooling operation. One or more of the steps of the method 200 may be executed by the controller 47. The method 200 includes operating the gas turbine engine (step 210). The method 200 also includes close the solenoid valve 88 to turn off flow of air from the air delivery system 76 to the water delivery system 74 (step 220), while the metering valve 78 is maintained in an open position to enable water flow in the water injection assembly 46 through the water delivery system 74.

The method 200 further includes operating the water injection assembly 46 under on-line water wash mode to spray non-atomized water/water droplets in front of the low pressure compressor 42 and the high pressure compressor 44 for cooling operation (step 230). Specifically, the non-atomized water (or demineralized water) is injected through the spray nozzles 104 and 98, positioned upstream and directly in front of the low pressure compressor 42 and the high pressure compressor 44 to clean each of the compressors 42 and 44. Water droplets travel through different stages of the low pressure compressor 42 and the high pressure compressor 44, and clean blades thoroughly. The water flow rate may be at least 20 gallon (or 75 liter) per minute into the low pressure compressor 42, and at least 13 gallon (or 49) per minute into the high pressure compressor 44. In another embodiment, method 200 may include operating the water injection assembly 46 under on-line water wash mode to spray non-atomized water/water droplets in front of only one of the compressors 42 and 44, and the other compressor 42 or 44 may be washed via a traditional on-line water wash method.

Further, the method 200 includes ceasing the on-line water wash operation upon completion of the on-line water wash operation and preparing the water injection assembly 46 for cooling operation (step 240), which includes opening the solenoid valve 88 to enable flow of air from the air delivery system 76 to the water delivery system 74. In addition, the controller 47 may control/regulate the metering valve 78 and/or the orifices 100 and 94 such that the amount and rate of the water flow into the low pressure compressor 42 and the high pressure compressor 44 are adjusted for the water injection assembly 46 to operate under cooling mode. The method 200 also includes spraying atomized water via the water injection assembly 46 in front of the low pressure compressor 42 and the high pressure compressor 44 to cool each of the compressors 42 and 44 (step 250).

Technical effects of the disclosed embodiments include operating a water injection assembly coupled to a gas turbine engine for both cooling and on-line water wash operations. In certain embodiments, during cooling operation, the water injection assembly sprays atomized water into each of the high and low pressure compressors of the gas turbine engine to cool the compressors while the gas turbine engine is in operation. In certain embodiments, during on-line water wash operation, the water injection assembly sprays non-atomized water into each of the compressors to clean the compressors while the gas turbine engine is in operation. In certain embodiments, a controller may execute one or more steps to operate the gas turbine engine and perform cooling operation or on-line water wash operation. In this way, the efficiency of the compressors may be recovered and the downtime of the turbine engine may be reduced due to the cooling and on-line water wash operations.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A combined water-wash and water injection cooling system for a gas turbine engine, comprising:
a water delivery system configured to couple to the gas turbine engine, comprising:
a water conduit; and
one or more spray nozzles coupled to the water conduit and configured to spray a fluid into a compressor of the gas turbine engine;
an air delivery system configured to couple to the compressor and to the water delivery system, comprising:
an air conduit coupled to the water conduit, wherein the air delivery system is configured to provide air from the compressor to the water delivery system so that the one or more spray nozzles spray atomized water into the gas turbine engine into the compressor, during a cooling operation mode to cool the compressor; and
a controller configured to couple to the gas turbine engine, the water delivery system, and the air delivery system, wherein the controller comprises a memory encoding one or more processor-executable routines and a processor configured to access and execute the one or more routines encoded by the memory, wherein the routines, when executed cause the processor to turn off air from flowing from the air delivery system to the water delivery system to enable the one or more spray nozzles to spray non-atomized water into the compressor of the gas turbine engine, during an on-line water wash mode to wash the compressor.

2. The system of claim 1, comprising the gas turbine engine, wherein the gas turbine engine comprises:
the compressor, wherein the compressor comprises a low pressure compressor located upstream of a high pressure compressor;
a combustion system; and
a turbine section.

3. The system of claim 1, wherein the one or more spray nozzles are configured to spray the fluid into the gas turbine engine downstream of the low pressure compressor and upstream of the high pressure compressor during the on-line water wash mode to wash the high pressure compressor.

4. The system of claim 3, wherein the on-line water wash mode is configured to spray at least 49 liters per minute into the gas turbine engine downstream of the low pressure compressor and upstream of the high pressure compressor via the one or more spray nozzles.

5. The system of claim 3, wherein the one or more spray nozzles are configured to spray the fluid into the gas turbine engine upstream of the low pressure compressor during the on-line water wash mode to wash the compressor

6. The system of claim 5, wherein the on-line water wash mode is configured to spray at least 75 liters per minute into the gas turbine engine upstream of the low pressure compressor via the one or more spray nozzles.

7. The system of claim 1, wherein the air delivery system comprises a solenoid valve disposed along the air conduit upstream of where the air conduit is coupled to the water conduit.

8. The system of claim 7, wherein the controller is configured to maintain the solenoid valve in an open position, via an actuator, to enable air to flow from the air delivery system to the water delivery system during the cooling operation mode.

9. The system of claim 8, wherein the controller is configured to maintain the solenoid valve in a closed position, via the actuator, to turn off air from flowing from the air delivery system to the water delivery system during the on-line water wash mode.

10. A method, comprising;
operating a combined water-wash and water injection cooling system coupled to a gas turbine engine;
turning off, via a first control signal from a controller, a flow of air from an air delivery system coupled to a compressor of the gas turbine engine to a water delivery system; and
in an on-line water wash mode to wash the compressor, spraying water, via the water delivery system, into the compressor of the gas turbine engine while the gas turbine engine is operating and subsequent to turning off the flow of air from the air delivery system to the water delivery system.

11. The method of claim 10, wherein spraying water into the compressor of gas turbine engine during the on-line water wash mode comprises spraying water into a high pressure compressor of the gas turbine engine at a first location downstream of a low pressure compressor and upstream of the high pressure compressor.

12. The method of claim 11, wherein spraying water into the gas turbine engine upstream of the compressor at the first location while the gas turbine engine is operating and subsequent to turning off the flow of air from the air delivery system to the water delivery system comprises spraying water at a rate of at least 49 liters per minute at the first location.

13. The method of claim 11, wherein spraying water into the compressor of the gas turbine engine during the on-line water wash mode comprises spraying water into a low pressure compressor of the gas turbine engine at a second location upstream of the low pressure compressor.

14. The method of claim 13, wherein spraying water into the gas turbine engine at the second location while the gas turbine engine is operating and subsequent to turning off the flow of air from the air delivery system to the water delivery system comprises spraying water at a rate of at least 75 liters per minute at the second location.

15. The method of claim 10, wherein turning off the flow of air from the air delivery system to the water delivery system comprises closing a solenoid valve disposed along an air conduit of the air delivery system upstream of the water delivery system.

16. The method of claim 10, comprising:
enabling, via a second control signal from the controller, the flow of air from the air delivery system to the water delivery system; and
in a cooling mode to the cool the compressor, spraying atomized water, via the water delivery system, into the compressor of the gas turbine engine while the gas turbine engine is operating and subsequent to enabling the flow of air from the air delivery system to the water delivery system.

17. The method of claim 16, wherein enabling the flow of air from the air delivery system to the water delivery system comprises opening a solenoid valve disposed along an air conduit of the air delivery system upstream of the water delivery system.

18. A gas turbine engine controller, comprising:
a memory encoding one or more processor-executable routines; and
a processor programmed to access and execute the one or more routines encoded by the memory, wherein the routines, when executed cause the processor:
to turn off a flow of air from a compressor of a gas turbine engine, via an air delivery system, to a water delivery system; and
subsequent to blocking the flow of air, spray water via the water delivery system into the compressor of the gas turbine engine while the gas turbine engine is operating to clean the compressor.

19. The gas turbine engine controller of claim 18, wherein the processor is programmed to access and execute the one or more routines to block the flow of air from the compressor of the gas turbine engine, via the air delivery system, to the water delivery system, by closing a solenoid valve positioned along an air conduit of the air delivery system.

20. The gas turbine engine controller of claim 17, wherein the processor is programmed to access and execute the one or more routines, subsequent to turning off the flow of air to spray water via the water delivery system into the compressor of the gas turbine engine at a first water flow rate at a first location upstream of a low pressure compressor of the gas turbine engine and at a second water flow rate at a second location downstream of the low pressure compressor and upstream of a high pressure compressor, wherein the first water flow rate is at least 75 liters per minute, and the second water flow rate is at least 49 liters per minute and less than the first water flow rate.
